(19) United States
(12) Patent Application Publication
(10) Pub. No.: US 2009/0280825 A1
(43) Pub. Date: Nov. 12, 2009

(54) Device and Method for Sensing and Locating Cellular Phones

(76) Inventors: Ajay MALIK, Santa Clara, CA (US); Robert Perri, Bartlett, IL (US)

Correspondence Address: MOTOROLA, INC., 1303 EAST ALGONQUIN ROAD, IL01/3RD, SCHAUMBURG, IL, 60196, US

(21) Appl. No.: 12/118,024

(22) Filed: May 9, 2008

(51) Int. Cl. H04Q 7/20

(52) U.S. Cl. 455/456.1

(57) ABSTRACT

Described are device and method for sensing and locating cellular phones. The device may include (a) a sensor receiving broadcasts from activated cellular phones disposed in a predetermined area, the cellular phones being unassociated with the device; and (b) a processor coupled to the sensor to receive the broadcasts. The processor processes the broadcasts to determine a presence of each of the cellular phones.

### FIELD OF THE INVENTION

The present invention relates generally to a device and method for sensing and locating cellular phones. Specifically, a sensor of the device is configured to sense and locate the cellular phones.

### BACKGROUND

Locating an object of interest may be an essential feature required for a given area. For example, law enforcement agencies, airlines, court rooms, etc. may want to ensure that communication devices that are not associated therewith are not activated. Unassociated, activated communication devices may interfere with other communication devices that are to be used in the given area. For example, airlines may require a particular frequency to be free so that incoming and outgoing transmissions may be sent. However, an unassociated communication device may occupy that frequency preventing the transmissions. In another example, a court room may require silence aside from permitted parties from speaking. An incoming call on a cell phone may interrupt the court proceedings.

### SUMMARY OF THE INVENTION

The present invention relates to a device and method for sensing and locating cellular phones. The device according to an exemplary embodiment of the present invention may include (a) a sensor receiving broadcasts from activated cellular phones disposed in a predetermined area, the cellular phones being unassociated with the device; and (b) a processor coupled to the sensor to receive the broadcasts. The processor processes the broadcasts to determine a presence of each of the cellular phones.

### DESCRIPTION OF THE DRAWINGS

FIG. 1a shows a mobile unit according to a first exemplary embodiment of the present invention.

FIG. 1b shows a mobile unit according to a second exemplary embodiment of the present invention.

FIG. 2 shows an area in which the mobile unit of FIG. 1a or 1b senses and locates communications devices according to an exemplary embodiment of the present invention.

FIG. 3 shows a method for sensing and locating a communications device according to an exemplary embodiment of the present invention.

### DETAILED DESCRIPTION

The exemplary embodiments of the present invention may be further understood with reference to the following description and the appended drawings, wherein like elements are referred to with the same reference numerals. The exemplary embodiments of the present invention describe a device and method for sensing and locating a cellular phone in a given area. The sensing device may be a mobile unit (MU) such as a handheld mobile computer. A sensor adapted for the sensing and locating is a component of the MU. The MU, the sensor, and the method will be discussed in further detail below.

The exemplary embodiments of the present invention relate to detection of a cellular phone. However, it should be noted that the cellular phones may generally relate to any activated communications device such as any device with a communications component that may transmit and/or receive data from an internetwork, an intranetwork, a local area network, a wide area network, etc. Furthermore, it should be noted that the communications device may be in a sleep mode or other “deactivated” state but if the communications component such as a transceiver is still active, such a device is still considered an activated communications device.

It should also be noted that the communications devices that the device of the exemplary embodiments of the present invention senses and locates may not be, for example, part of a common network associated with the sensing device. That is, the communications devices may be wholly unassociated with the device. As will be discussed in further detail below, the sensing device of the exemplary embodiments may be configured to detect unassociated communications devices.

It should be further noted that the term “unassociated” may relate to when the sensing device and the communications device operate using different communication protocols. For example, the sensing device may communicate with a network using a first protocol while the communications device may communicate with another network using a second protocol. The first and second protocols may use different frequencies that are far enough apart that no interference is created.

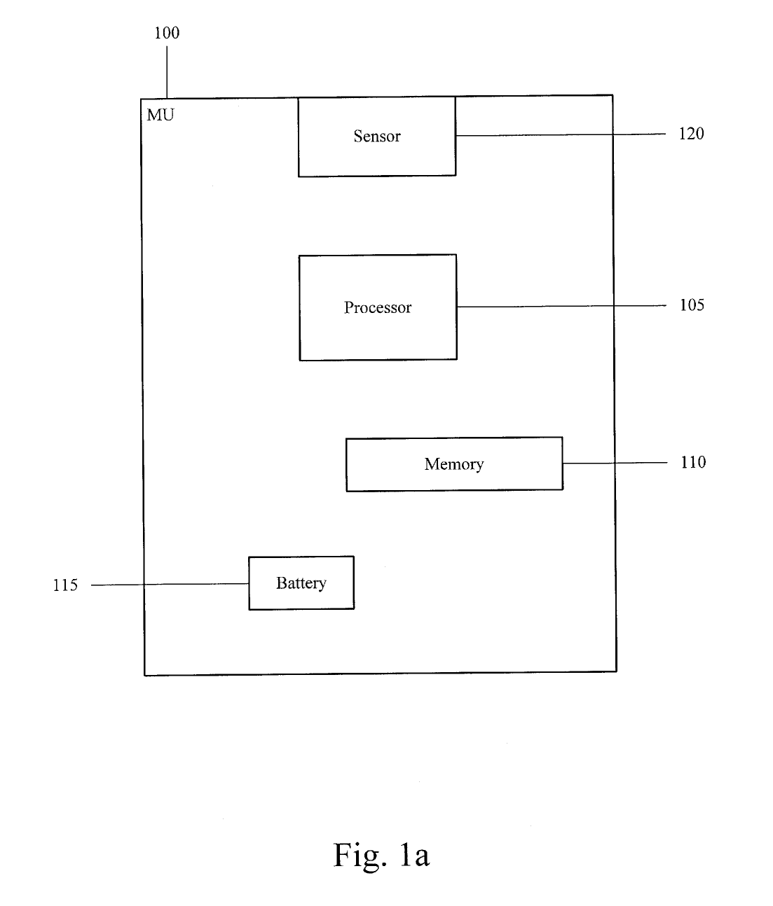

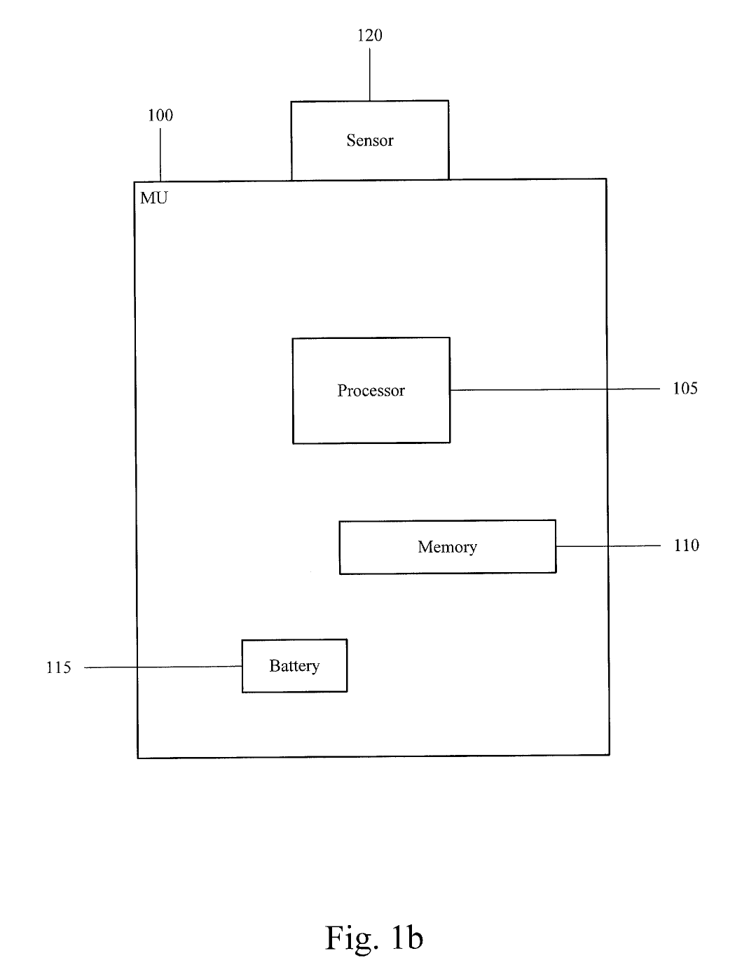

FIG. 1a shows a mobile unit (MU) 100 according to a first exemplary embodiment of the present invention. The MU 100 may be any electronic device such as a mobile computer, a desktop computer, a personal digital assistant (PDA), a laptop, a cell phone, a radio frequency identification reader, a scanner, an image capturing device, etc. The MU 100 may be portable or stationary and may include a portable power supply. The MU 100 may include a processor 105, a memory 110, a battery 115, and a sensor 120.

It should be noted that the MU 100 being illustrated as a stand alone device capable of performing the sensing and locating according to the exemplary embodiments of the present invention is only exemplary. In another exemplary embodiment, the MU 100 may be coupled (wired or wirelessly) to another stationary computing device. For example, in a wired embodiment, the MU 100 may include a port in which one side of a connector is received while a second side of the connector is received by a port of the stationary computing device. The connector may transmit data from the MU 100 to the stationary computing device for processing. Upon being processed, second data relating to the sensing and locating may be transmitted back to the MU 100. In yet another exemplary embodiment, the MU 100 may be part of a network. The MU 100 may include a transceiver in which data is transmitted and/or received to, for example, a server. The network may include a database and processor to receive the data from the MU 100 for processing. Upon being processed, second data relating to the sensing and locating may be transmitted back to the MU 100.

The processor 105 may be responsible for executing various functionalities of the MU 100. Specifically, according to the exemplary embodiments of the present invention, the processor 105 may be responsible for interpreting data relating to the sensing and locating of cellular phones in an area. The memory 110 may be a storage unit for the MU 100. Specifically, the memory 110 may store a database of parameters related to the sensing and locating of cellular phones in an area. As discussed above, the MU 100 may be configured to transmit data to another stationary computing device through a connector or network. The stationary computing device may include the database of parameters. In such an embodiment, the MU 100 may not include the database. The memory 100 may also store data and/or settings pertaining to various other functionalities of the MU 100. As discussed above, the MU 100 may include a portable power supply. As illustrated, the MU 100 may include the battery 115 to supply the necessary energy to operate the MU 100. When the MU 100 is stationary, the battery 115 may serve as a reserve power supply (e.g., when a main source of power such as a wall outlet is deactivated).

As illustrated in the first exemplary embodiment of FIG. 1a, the sensor 120 may be disposed as part of the MU 100 (e.g., within a housing of the MU 100). The sensor 120 may be configured to sense and/or locate cellular phones in a given area. The given area may be a finite space in which the MU 100 is disposed; a maximum sensing range of the sensor 120; etc. The sensor 120 may include a variety of components such as transmitters, antennas, etc. for the sensing and/or locating.

In an exemplary embodiment, the sensor 120 may receive a beacon and/or a ping from any activated communications device within a given area. The beacon may be in any format (e.g., substantially similar to an Internet control message protocol (ICMP) “echo request” packet transmitted by the cellular phone). A presence of such a beacon/ping when detected by the sensor 120 may indicate the presence of a communications device. When activated, the sensor 120 may listen for the beacon/ping.

A received signal strength indication (RSSI) of the beacon/ping may further be used to extrapolate a location. The signal strength may attenuate with known mathematical formulae in known environments. Thus, the received signal strength may be used to determine a distance from the sensor 120 that the communications device is disposed. The distance may indicate a radial distance from the sensor 120. An angle of receipt of the beacon/ping may also indicate a vector to pinpoint the communications device. The sensor 120 may include an antenna configuration that may determine the angle of receipt. For example, the antenna configuration may include a plurality of antennas operating at different polar diversities (e.g., orthogonal). It should be noted that the use of the beacon/ping to determine location is only exemplary. For example, the sensor 120 may broadcast a beacon that is used for the locating aspect. In such an example, the sensor 120 may also determine a round trip time to determine the location.

It should be noted that the sensor 120 may be configured to process all data that the sensor 120 transmits and receives to determine the sensing and locating. Thus, upon fully processing the requested data, the sensor 120 may transmit the processed data to the processor. That is, the sensor 120 may be equipped with its own processor. Once the processor receives the processed data, subsequent actions may be performed. For example, if cellular phones are present, a user may be notified on a display also including a number of cellular phones, an alarm may be sounded, etc. In another exemplary embodiment, the sensor 120 may transmit signals to the processor 105 to process raw data that the sensor 120 transmits and receives.

FIG. 1b shows a mobile unit (MU) 100 according to a second exemplary embodiment of the present invention. The MU 100 may be substantially similar to the MU 100 of FIG. 1a. That is, the MU 100 of FIG. 1b may be any electronic device that is portable or stationary and includes a portable power supply. The MU 100 of FIG. 1b may, therefore, include the processor 105, the memory 110, and the battery 115. However, in the second exemplary embodiment, the sensor 120 is disposed outside the housing of the MU 100. The sensor 120 may be an attachment to the MU 100, thereby enabling any mobile unit of receiving the sensor 120 attachment to be capable of sensing and locating cellular phones in a given area. In a first example, the MU 100 may include a port such as a Universal serial bus (USB) that receives a connector of the attachment. In a second example, the MU 100 may include a radio frequency (RF) port that receives RF signals from the attachment.

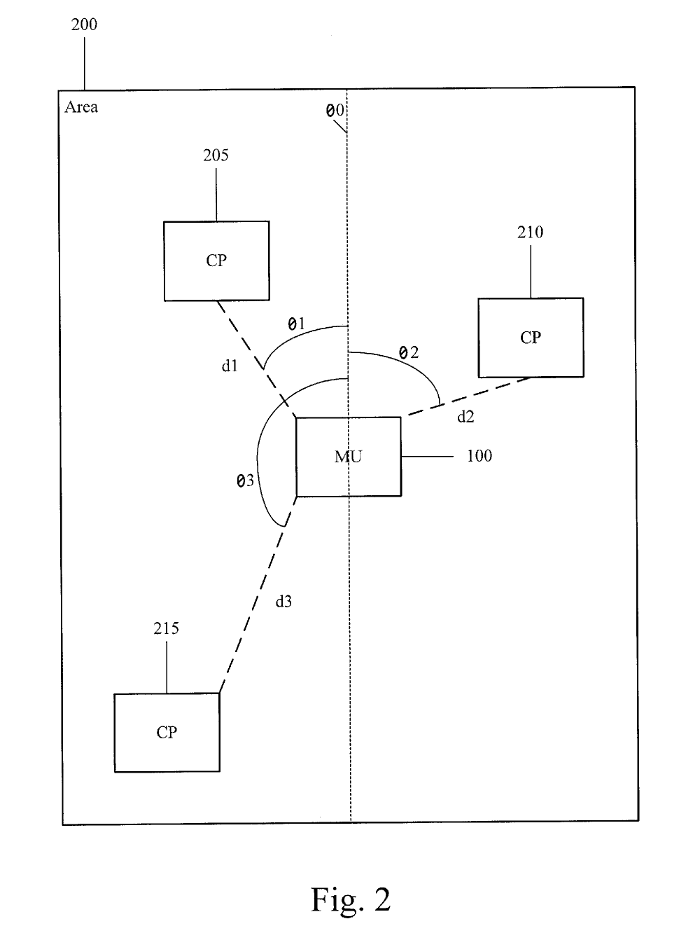

FIG. 2 shows an area 200 in which the MU 100 of FIG. 1a or 1b senses and locates cellular phones 205-215 according to an exemplary embodiment of the present invention. The area 200 may be, for example, a room. However, as discussed above, the area 200 may also be, for example, a maximum or partial scanning area of the sensor 120. As illustrated, the cellular phones 205-215 are disposed within the area 200. As discussed above, the cellular phones 205-215 may represent general communication devices such as personal digital assistants (PDAs) with network capabilities, pagers, laptops with network capabilities, two-way radios, etc.

The sensor 120 of the MU 100 may sense the cellular phones 205-215. That is, the sensor 120 may indicate the presence of three cellular phones (where at least a communications component is active). As discussed above in an exemplary embodiment, the sensor 120 may listen for a beacon/ping transmitted from the cellular phones 205-215. It should be noted that the area 200 may include other cellular phones. However, if these other cellular phones are deactivated, then the sensor 120 cannot determine their presence and would not indicate that these other deactivated cellular phones are disposed in the area 200.

Also, as discussed above, the sensor 120 may be configured to determine an approximate location of each of the cellular phones 205-215. For example, the beacon/ping transmitted from the cellular phones 205-215 may include a round-trip time that may be used to extrapolate a distance. As illustrated, the cellular phone 205 is a distance d1 from the MU 100; the cellular phone 210 is a distance d2 from the MU 100; and the cellular phone 215 is a distance d3 from the MU 100. Furthermore, an angle of receipt of the beacon/ping from a zero angle line (θ0) may indicate that the cellular phone 205 is a distance d1 at an angle θ1 counterclockwise from θ0; the cellular phone 210 is a distance d2 at an angle θ2 clockwise from θ0; and the cellular phone 215 is a distance d3 at an angle θ3 counterclockwise from θ0. Thus, a location of the cellular phones 205-215 may be determined using the sensor 120.

It should be noted that the use of the beacon and/or ping may represent any communication in which a communications device may transmit. For example, the ICMP may be a beacon that is transmitted by the communications device while in a first mode. In a second mode such as when the communications device is in a communicative mode (e.g., used as a telephone and transmitting voice packets), communicative packets (e.g., voice packets) may be received by the sensor 120 for the determining and/or locating.

It should be also noted that the processor of the MU 100 may receive and/or determine additional data to determine an approximate location for each of the cellular phones 205-215. For example, the MU 100 may receive and/or determine triangulation data, received signal strength data, etc. to be used for the locating of the cellular phones 205-215.

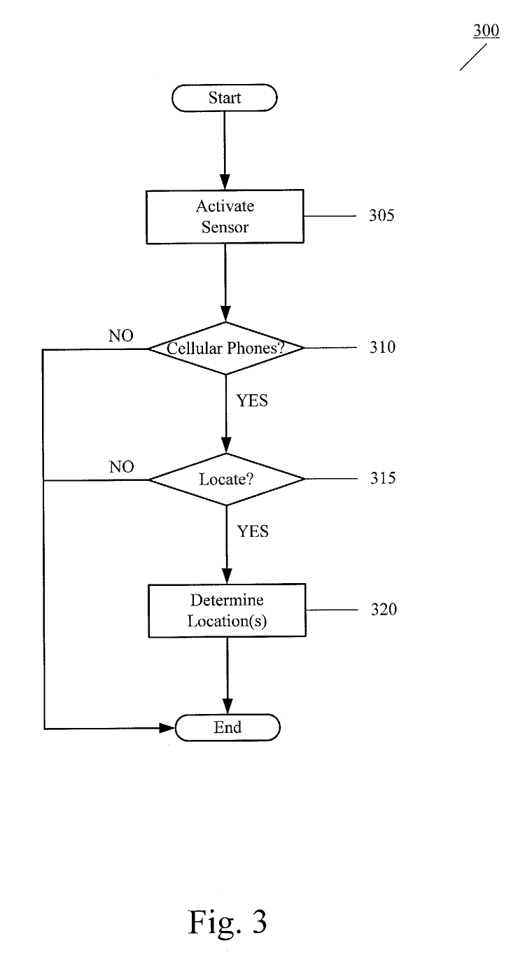

FIG. 3 shows a method 300 for sensing and locating a cellular phones according to an exemplary embodiment of the present invention. The method 300 will be described with reference to the MU 100 of FIG. 1a or 1b and the area 200 of FIG. 2.

In step 305, the sensor 120 is activated. It is assumed that a user wishes to determine the presence and/or location of cellular phones in a predetermined area such as the area 200. As described above, in a first exemplary embodiment, the sensor 120 may be a component of the MU 100. The sensor 120 may automatically be activated upon the activation of the MU 100, activated upon the activation of a program that executes the sensing and locating, individually activated, etc. In a second exemplary embodiment, the sensor 120 may be an attachment of the MU 100. The sensor 120 may be automatically activated upon being attached to the MU 100 or activated through any of the activating means described for the first exemplary embodiment above.

In step 310, a determination is made whether communications devices are present. As discussed above, the presence of the cellular phones may be performed with the sensor 120. The sensor 120 may wait to listen for any beacon/ping transmitted from the cellular phones. A reception of the beacon/ping may indicate the presence of the cellular phones. If no cellular phones are present or activated, the method 300 ends. If activated cellular phones are present, the method 300 continues to step 315.

In step 315, a determination is made whether to locate the cellular phones. If the locations are not to be determined, the method 300 ends. If the locations are to be determined, the method 300 continues to step 320 where the locations are determined. The location of the cellular phones may be determined using the beacon/ping transmitted from the cellular phones that were also used to determine the presence of the cellular phones. As discussed above, a received signal strength indication and an angle of reception of the beacon/ping may be used to extrapolate the location of each of the cellular phones that are present. Furthermore, when the sensor 120 is configured to transmit a beacon for the locating, a round trip time may be determined and used for the locating.

It should be noted that the method 300 may include additional steps. For example, upon determining the locations of the cellular phones in step 320, the locations may be displayed to a user on a display of the MU 100. In another example, the locations may also be referenced to a topology of the area. If the area includes a seating arrangement, the location may be analyzed in view of the seating arrangement to determine a seat (and a user in the seat) that has an activated cellular phone. In yet another example, the memory 110 of the MU 100 may include a database of parameters of the signatures of different types of cellular phone. A sensed transmission signature may include a specific set of parameters that a comparison may indicate a make and/or model of the cellular phone that is present in the area.

The exemplary embodiments of the present invention may provide advantages to a variety of situations. For example, an airline may ensure that a communication frequency is free by deactivating any device within a predetermined area without authorization to use the frequency. In another example, a court room may ensure that a proceeding is not interrupted through a disruptive phone call. In yet another example, a law enforcement agency may ensure that a cellular phone is present and then deactivating the phone during an arrest.

The exemplary embodiments of the present invention may also provide determining and locating communications device that are associated with any network in which the sensor 120 is not associated. For example, a first communications device may be associated with a first cellular network operating at a first frequency; a second communications device may be associated with a second cellular network operating at a second frequency; etc. The sensor 120 may be configured to detect and locate the communications devices at the different operating frequencies. For example, a user of the sensor 120 may set listening frequencies. In another example, the sensor 120 may be programmed with known, commonly used frequencies. In yet another example, the sensor 120 may listen to all available frequencies.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A device, comprising:
a sensor receiving broadcasts from activated cellular phones disposed in a predetermined area, the cellular phones being unassociated with the device; and
a processor coupled to the sensor to receive the broadcasts, the processor processing the broadcasts to determine a presence of each of the cellular phones.

2. The device of claim 1, wherein the processor further processes the broadcasts to determine a location of each of the cellular phones.

3. The device of claim 2, wherein the processor determines parameters of the broadcasts.

4. The device of claim 3, wherein the parameters include at least a received signal strength indication (RSSI) and an angle of receipt.

5. The device of claim 1, wherein the broadcast is an Internet control message protocol (ICMP) “echo request” packet.

6. The device of claim 1, wherein a size of the predetermined area is a function of a sensing capacity of the sensor.

7. The device of claim 1, wherein the broadcasts have a unique frequency.

8. The device of claim 2, wherein the processor further processes data relating to at least one of triangulation and a round trip time to determine the location of each of the cellular phones.

9. The device of claim 1, wherein the sensor is disposed within a housing of the device.

10. The device of claim 1, wherein the sensor is an attachment to the device.

11. A method, comprising:
receiving a broadcast with a sensing device from an activated cellular phone disposed in a predetermined area, the cellular phone being unassociated with the sensing device; and
processing the broadcast to determine a presence of the cellular phone.

12. The method of claim 11, further comprising:
processing the broadcast to determine a location of the cellular phone.

13. The method of claim 12, further comprising:
determining parameters of the broadcast.

14. The method of claim 13, wherein the parameters include at least a received signal strength indication and an angle of receipt.

15. The method of claim 11, wherein the broadcast is an ICMP “echo request” packet.

16. The method of claim 11, wherein a size of the predetermined area is a function of a sensing capacity of the sensing device.

17. The method of claim 11, wherein the broadcasts have a unique frequency.

18. The method of claim 12, further comprising:
processing data relating to at least one of triangulation and a round trip time to determine the location of the cellular phone.

19. The method of claim 12, further comprising:
displaying the location of the cellular phone.

20. A device, comprising:
a sensing means for receiving broadcasts from activated cellular phones disposed in a predetermined area, the cellular phones being unassociated with the device; and
a processing means for processing the broadcasts to determine a presence of each of the cellular phones, the processing means being coupled to the sensing means to receive the broadcasts.
